(19) United States
(12) Patent Application Publication
(10) Pub. No.: US 2002/0078931 A1
(43) Pub. Date: Jun. 27, 2002

(54) Canister

(75) Inventors: Katsuhiko Makino, Ohbu-shi (JP); Ryuji Kosugi, Ohbu-shi (JP); Tomonari Toki, Ohbu-shi (JP)

Correspondence Address: PILLSBURY WINTHROP, LLP, P.O. BOX 10500, MCLEAN, VA, 22102, US

(73) Assignee: Aisan Kogyo Kabushiki Kaisha, Ohbu-shi (JP)

(21) Appl. No.: 10/012,705

(22) Filed: Dec. 12, 2001

(30) Foreign Application Priority Data
Dec. 25, 2000 (JP) 2000-404629

(51) Int. Cl. F02M 33/02

(52) U.S. Cl. 123/519; 123/520

(57) ABSTRACT

A canister, for inhibiting a diffusion phenomenon in an adsorbent layer as much as possible and certainly adsorbing fed evaporated fuel to inhibit blow-by of the evaporated fuel into the atmosphere, is constituted by filling a first adsorbent layer of the canister with activated carbon A having a large evaporated fuel adsorption and a weak holding power, and filling a second and a third adsorbent layers with activated carbon B having an intermediate evaporated fuel adsorption and a weak holding power and therefore having characteristics that the residual amount of the low boiling point components in the evaporated fuel after purge is small, whereby after the high temperature standing of the canister, the discharge of the evaporated fuel into the atmosphere can be inhibited.

### FIELD OF THE INVENTION

The present invention relates to a canister for an evaporated fuel treating apparatus of an internal combustion engine, and more specifically, it relates to a canister capable of preventing the discharge of an evaporated fuel into the atmosphere.

### DESCRIPTION OF THE RELATED ART

In a conventional canister for an evaporated fuel treating apparatus, an evaporated fuel generated from a fuel tank is adsorbed by an adsorbent received in a canister container during the stop of the engine, and the adsorbed fuel is purged by a negative pressure of an intake pipe and then burnt in a combustion chamber, after the start of the engine.

In this kind of canister, the so-called blow-by phenomenon takes place in which the evaporated fuel is not completely adsorbed during the stop of the engine and then discharged into the atmosphere through an atmosphere port through which the atmospheric air is introduced. This blow-by phenomenon occurs as follows: an automobile is allowed to stand for a predetermined time in a high temperature atmosphere after the drive of the automobile and the stop of the engine, so that the evaporated fuel which remains in the adsorbent evaporates and diffuses in an adsorbent layer on the side of the atmosphere port to bring about the so-called diffusion phenomenon. Afterward, the diffused evaporated fuel is pushed out by the evaporated fuel fed from a fuel tank and then released into the atmosphere through the atmosphere port, thereby giving rise to the blow-by phenomenon.

This blow-by phenomenon often takes place in the conventional canister in which activated carbon A (which will hereinafter be described in detail) having characteristics that an adsorption amount of the evaporated fuel is large is used as the adsorbent in order to make the canister compact. FIG. 5 is a graph showing the blow-by amount with respect to the feed of the evaporated fuel from the fuel tank. FIG. 6 is a vertically sectional view of the conventional canister. The graph in FIG. 5 shows the results of a test conducted in accordance with a test procedure indicated in the drawing. That is to say, purging is first done for a predetermined time from a breakthrough condition of a canister 31 in FIG. 6. This operation is repeated to stabilize the evaporated fuel, whereby a remaining amount is constantly maintained. Afterward, the canister is allowed to stand at a high temperature, and after an elapse of 36 hours, the evaporated fuel is fed to a tank port 2d of the canister 31 at a flow rate of 15 g per hour, considering the evaporated fuel which flows from a fuel tank 9 into the canister 31. Under this condition, a blow-by amount passing through an atmosphere port 2h to an inflow is measured. The blow-by amount in a conventional technique I shown in FIG. 6 where an activated charcoal A (5a) alone is used as the adsorbent is as much as about 140 mg in the case that the inflow of the evaporated fuel from the fuel tank 9 is 80 g. This reason is considered as follows: low boiling point components in the evaporated fuel which have not been purged and remain in deep portions of pores of the activated carbon evaporate and fill on a downstream side owing to a diffusion phenomenon while the canister is allowed to stand in a high temperature environment, and afterward, the low boiling point components are pushed out by the evaporated fuel subsequently fed from the fuel tank 9 and then released into the atmosphere.

Accordingly, as an improved technique for the above situations, a device is disclosed in JP-U-5768163. According to the device disclosed in this publication, a plurality of activated carbon layers for fuel adsorption are disposed. An activated carbon layer of activated carbon having a weak fuel adsorbability and a large effective adsorption of the fuel is arranged on the side of a communicating orifice toward a fuel tank or an engine inlet system, and another activated carbon layer of activated carbon having a strong fuel adsorbability and a small effective adsorption of the fuel and scarcely bringing about the breakthrough of the fuel before the saturation state of an adsorptive function is arranged on the side of an atmosphere releasing orifice. Most of the fuel vapor fed from the fuel tank is adsorbed by the activated carbon on the side of the communicating orifice, and a slight part of the vapor which has broken through the activated carbon is adsorbed by the activated carbon on the side of the atmosphere releasing orifice, so that the fuel vapor is certainly adsorbed by the activated carbon layer.

However, in a conventional technique II not shown which is a combination of the above activated carbon having the weak fuel adsorbability (hereinafter referred to as “holding power”) and the large effective adsorption (the activated carbon A in the present invention) and activated carbon layer of activated carbon having the strong fuel holding power and the small effective adsorption (the activated carbon C in the present invention), the blow-by amount is much smaller, about 65 mg, than that in the conventional technique I in the case that an inflow of the evaporated fuel from a tank port is 80 g, as shown in FIG. 5. However, the above blow-by amount is still insufficient, as compared with a desired value (50 mg) of the blow-bye amount after standing. This is considered to be due to a fact that the low boiling point components in the evaporated fuel remain in large quantities after the purge owing to characteristics of the above-mentioned activated carbons A and C, as shown in FIG. 4, and thus, a diffusion phenomenon occurs during the high-temperature standing, so that these components are pushed out by the evaporated fuel subsequently fed from the tank port and then released into the atmosphere.

In consequence, an object of the present invention is provide a canister which can inhibit the diffusion phenomenon in an adsorbent layer of the canister as much as possible and which can certainly adsorb a flown evaporated fuel to inhibit the blow-by of the fuel into the atmosphere.

### SUMMARY OF THE INVENTION

For the solution of the above problem, a first aspect of the present invention is directed to a canister in which adsorbent layers of a first layer and a second layer obtained by dividing an adsorbent layer with a partition wall are arrange in series, wherein the adsorbent layer of the first layer is filled with activated carbon (activated carbon A) having a large evaporated fuel adsorption and a weak holding power, and the adsorbent layer of the second layer is filled with activated carbon (activated carbon B) having an intermediate evaporated fuel adsorption and a weak holding power.

Further, the adsorbent layer of the second layer can be divided into two portions by a filter or a plate having air permeability to form a second and a third adsorbent layer in the case that the adsorbent layer of the first layer is referred to as the first adsorbent layer.

In addition, a second aspect of the present invention is directed to a canister in which adsorbent layers of a first layer and a second layer obtained by dividing an adsorbent layer with a partition wall are arrange in series, wherein the adsorbent layer of the second layer is divided into two portions by a filter or a plate having air permeability to form a second and a third adsorbent layer; the adsorbent layer of the first layer, i.e., the first adsorbent layer is filled with activated carbon (activated carbon A) having a large evaporated fuel adsorption and a weak holding power; the second adsorbent layer is filled with activated carbon (activated carbon B) having an intermediate evaporated fuel adsorption and a weak holding power; and the third adsorbent layer is filled with activated carbon (activated carbon C) having a small evaporated fuel adsorption and a strong holding power.

Moreover, the volume of the third adsorbent layer may be set in a range of from 2.3 to 4.8% of the volume of the total adsorbent layers.

### BRIEF DESCRIPTION OF THE DRAWINGS

FIG. 1 is a vertically sectional view of a canister according to a first embodiment of the present invention.

FIG. 2 is a vertically sectional view of a modification of the embodiment in FIG. 1.

FIG. 3 is a vertically sectional view of a canister according to a second embodiment of the present invention.

FIG. 4 is a list showing the characteristics of activated carbons used in the present invention.

FIG. 5 is a graph showing the measured test results of blow-by amounts of conventional canisters and the canisters according to the present invention.

FIG. 6 is a vertically sectional view of the canister showing a conventional technique I.

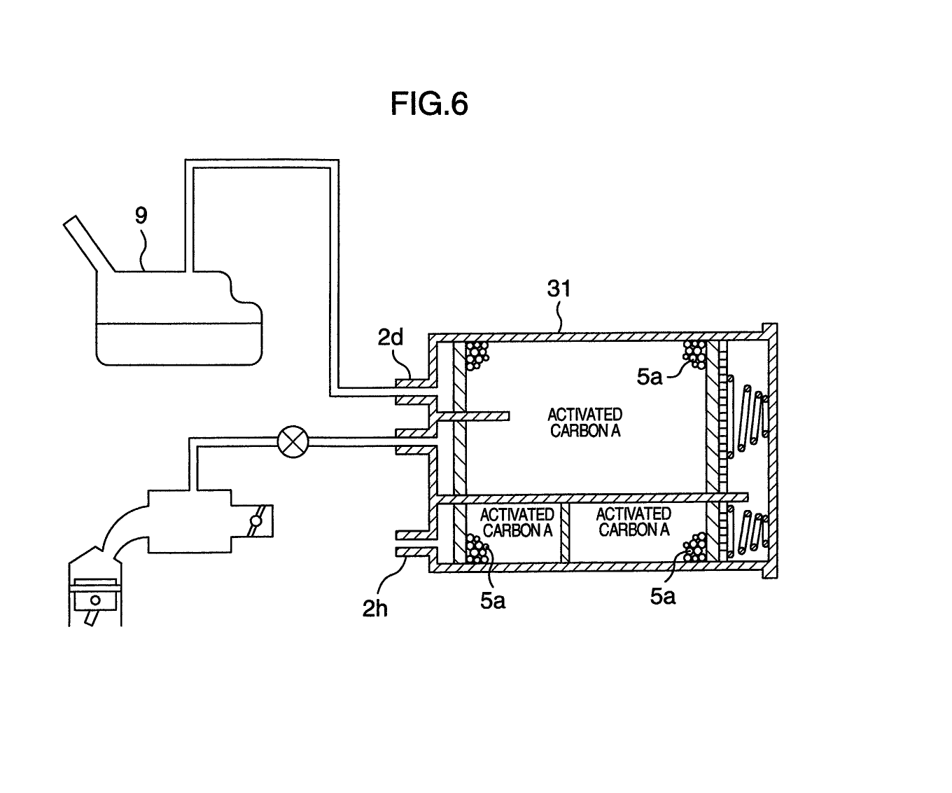

### DETAILED DESCRIPTION OF THE INVENTION

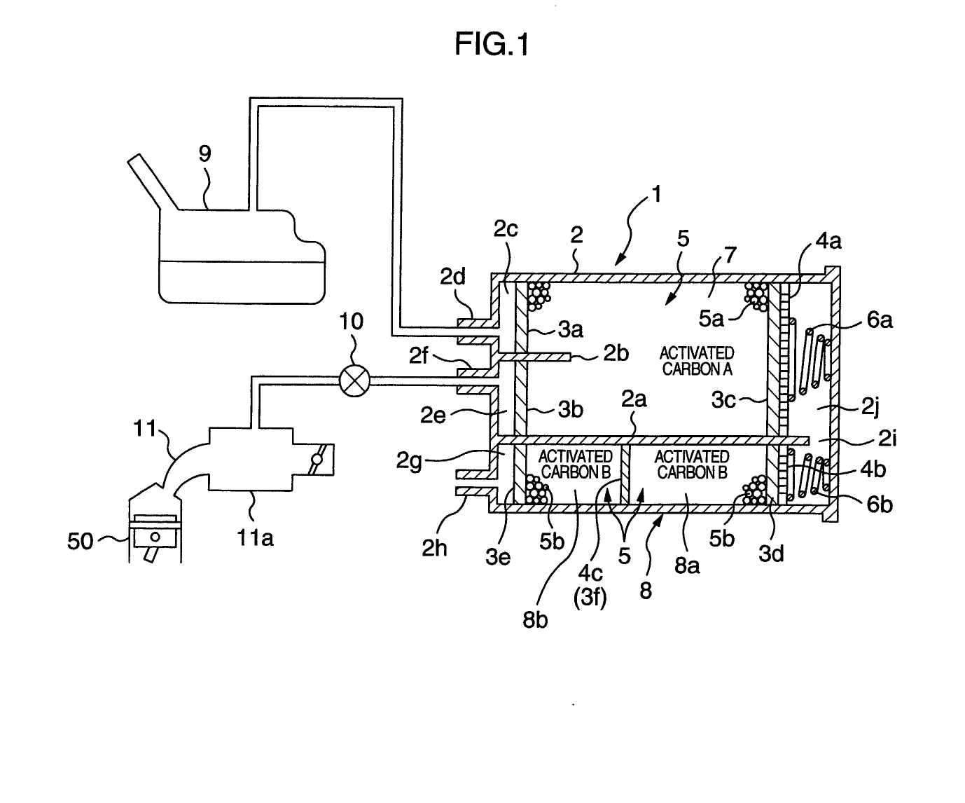

Desired embodiments according to the present invention will be described in reference to drawings. FIG. 1 is a vertically sectional view of a canister according to a first embodiment of the present invention. In FIG. 1, the interior of a case 2 constituting a canister 1 is divided into two portions by a partition wall 2a. In one portion, an adsorbent 5 held between filters 3a, 3b, 3c having air permeability is pressed by a spring 6a via a plate 4a having an air permeability, for example, a perforated plate 4a to form an adsorbent layer of a first layer, i.e., a first adsorbent layer 7. In another portion, similarly, the adsorbent 5 held between filters 3d and 3e having the air permeability is pressed by a spring 6b via a plate 4b having the air permeability, for example, a perforated plate 4b to form an adsorbent layer 8 of a second layer. This adsorbent layer 8 of the second layer is partitioned into two portions by a plate 4c having the air permeability, for example, a perforated plate 4c or a filter 3f to form a second adsorbent layer 8a and a third adsorbent layer 8b.

Through a first space portion 2c defined by the case 2, the filter 3a and a division plate 2b, a tank port 2d is opened which is connected to the upper portion of a fuel tank 9. Through a second space portion 2e defined by the case 2, the filter 3b and the division plate 2b, a purge port 2f is opened which is connected to a surging tank 11a on an intake pipe 11 via a flow regulating valve 10. Through a third space portion 2g defined by the case 2, the filter 3e and the partition wall 2a, an atmosphere port 2h is opened which is connected to the atmosphere. At the tip of the partition wall 2a, a communicating path 2i is disposed, and a fourth space portion 2j is defined by the case 2 and the plates 4a, 4b. Thus, the adsorbent layers 7, 8a, 8b are arranged in series to the flow of an evaporated fuel via the fourth space portion 2j.

The first adsorbent layer 7 is filled, as the adsorbent 5, with activated carbon A (5a) having a large evaporated fuel adsorption and a weak holding power and therefore containing low boiling point components of the evaporated fuel which remain in large quantities after purge. The second adsorbent layer 8a and the third adsorbent layer 8b are each filled with activated carbon B (5b) having an intermediate evaporated fuel adsorption and a weak holding power and therefore containing the low boiling point components in the evaporated fuel which slightly remain after the purge. It is to be noted that the respective layers are constituted so that the volume of the third adsorbent layer 8b may be 300 cc, that of the first adsorbent layer 7 may be 1400 cc, and that of the total adsorbent layers may be 2100 cc. In this case, the plate 4c or the filter 3f separating the second adsorbent layer 8a from the third adsorbent layer 8b may be removed, because the kinds of activated carbon 5 in both the adsorbent layers 8a, 8b are the same, and such a removal thereof is economical.

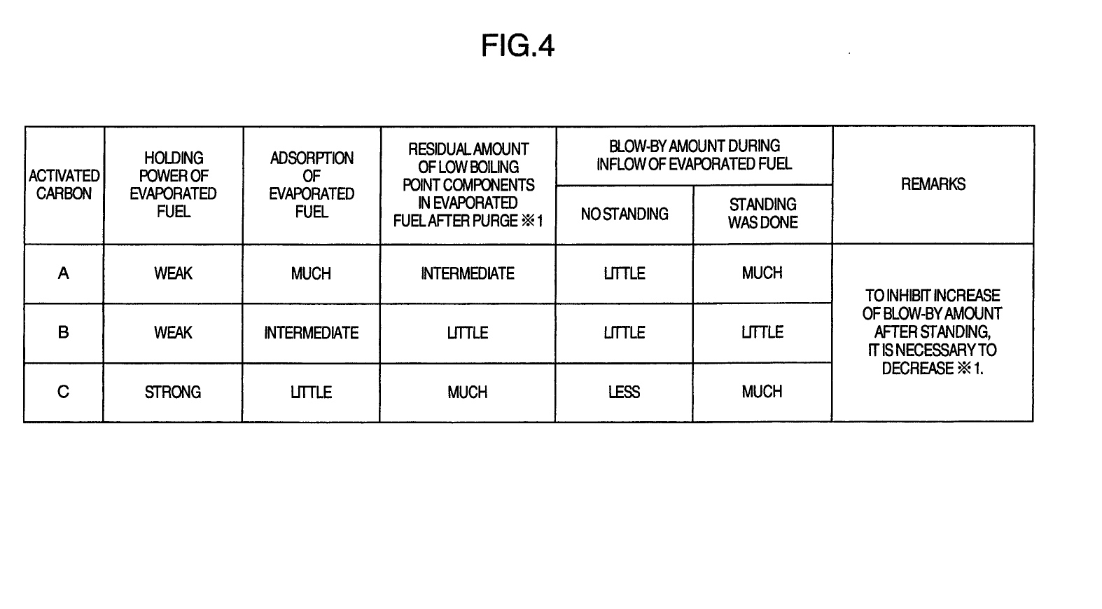

Here, the characteristics of the above respective activated carbons used in the present invention will be described with reference to FIG. 4. In FIG. 4, the activated carbon A has the characteristics that the evaporated fuel adsorption is large and the holding power is weak, and therefore, the amount of the low boiling point components in the evaporated fuel which remain after the purge is intermediate among the activated carbons A, B and C. The activated carbon B has the characteristics that the evaporated fuel adsorption is intermediate and the holding power is weak, and therefore, a small amount of the low boiling point components in the evaporated fuel remains after the purge. The activated carbon C has the characteristics that the evaporated fuel adsorption is small and the holding power is strong, and therefore, a large amount of the low boiling point components in the evaporated fuel remains after the purge.

With regard to the blow-by amount during the inflow of the evaporated fuel from the fuel tank, in the case that the canister is allowed to stand at a high temperature for a predetermined time after the purge, i.e., in the case that standing is done, the blow-by amounts of the activated carbons A and C are large, but that of the activated carbon B is small. This is considered to be due to a fact that the low boiling point components in the evaporated fuel which remain in the activated carbon after the purge evaporates during the standing at the high temperature to bring about a diffusion phenomenon, so that the canister is filled with the components and these components are pushed out by the evaporated fuel to give rise to the blow-by. That is to say, in the activated carbons A and C, the blow-by amount is large, and in the activated carbon B, the blow-by amount is small.

However, in the case that the standing is not carried out at the high temperature after the purge, i.e., in the case of no standing, in all of the activated carbons A, B and C, the blow-by amount is small. This is due to a fact that even if the low boiling point components in the evaporated fuel remain in the activated carbons, any diffusion phenomenon by the evaporation of the low boiling point components does not occur, because any high-temperature standing is not present. Therefore, in order to inhibit the increase of the blow-by amount after the high-temperature standing, it is necessary that the amount of the low boiling point components in the evaporated fuel which remains after the purge is small. It is to be noted that the above activated carbons having the various characteristics can easily be manufactured by a manufacturer of the activated carbons in accordance with requested characteristics.

Next, the function of the first embodiment will be described. In FIG. 1, the evaporated fuel generated from the fuel tank 9 during the stop of an engine is allowed to flow through the tank port 2d into the activated carbon A (5a) in the first adsorbent layer 7 and then the activated carbon B (5b) in the second adsorbent layer 8a and the second adsorbent layer 8b, in which the evaporated fuel is adsorbed in turn, whereby the blow-by of the fuel into the atmosphere is inhibited. Next, when the engine 50 is started, the evaporated fuel adsorbed by the activated carbons A (5a) and B (5b) is purged through a purge port 2f together with the atmospheric air introduced through an atmosphere port 2h by a negative pressure of the intake pipe 11. After they have been purged for a predetermined time, the engine 50 is stopped, and the vehicle is allowed to stand for a predetermined time in a room maintained at a predetermined temperature.

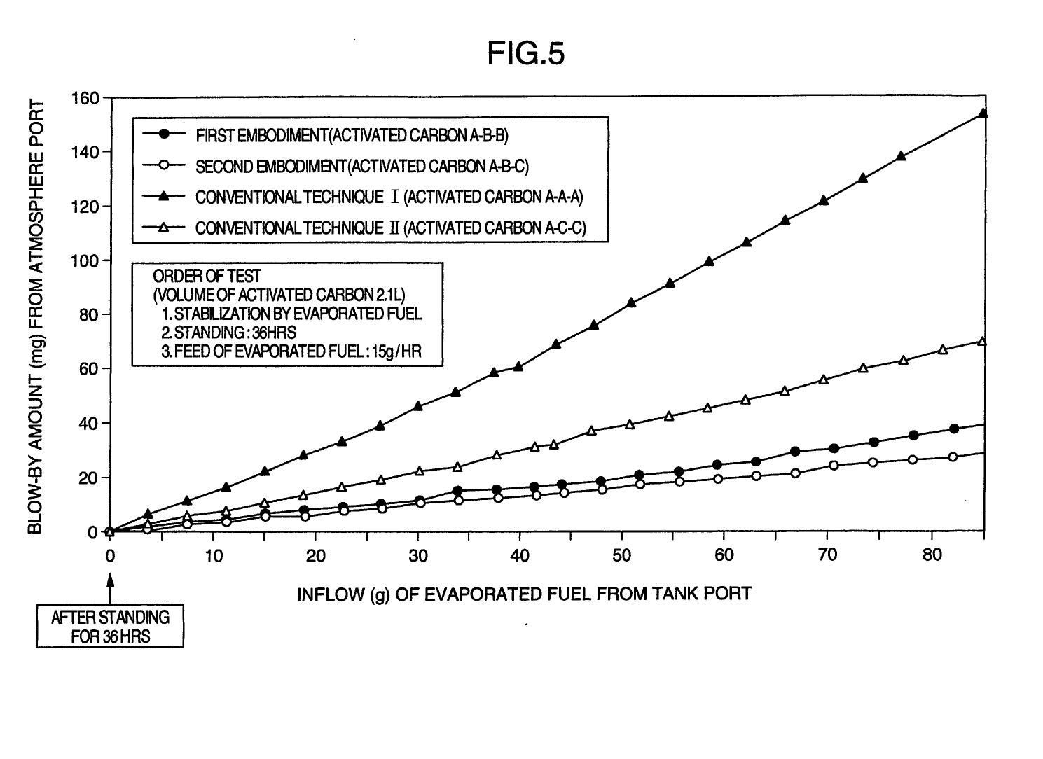

While this period of time, the canister 1 is allowed to stand at a high temperature in a state where a predetermined amount of the low boiling point components is present in the activated carbon A (5a), and hence, the remaining fuel evaporates and diffuses to flow toward the downstream of the canister 1, but is then adsorbed by the activated carbon B (5b) in the second and the third adsorbent layers 8a, 8b in which the remaining amount of the fuel is small. Afterward, the evaporated fuel fed from the fuel tank 9 is also adsorbed by the activated carbon B (5b), and hence, the discharge of the evaporated fuel into the atmosphere can be certainly inhibited. In FIG. 5, the blow-by amount is less than 40 mg in the case that the feed of the evaporated fuel is 80 g, which means that the blow-by amount remarkably decreases as compared with the conventional techniques I and II. It is to be noted that the volume of the total adsorbent layers in the canister used for the measurement of the blow-by in FIG. 5 is 2100 cc, that of the first adsorbent layer 7 is 1400 cc, and that of the third adsorbent layer 8b may be 300 cc.

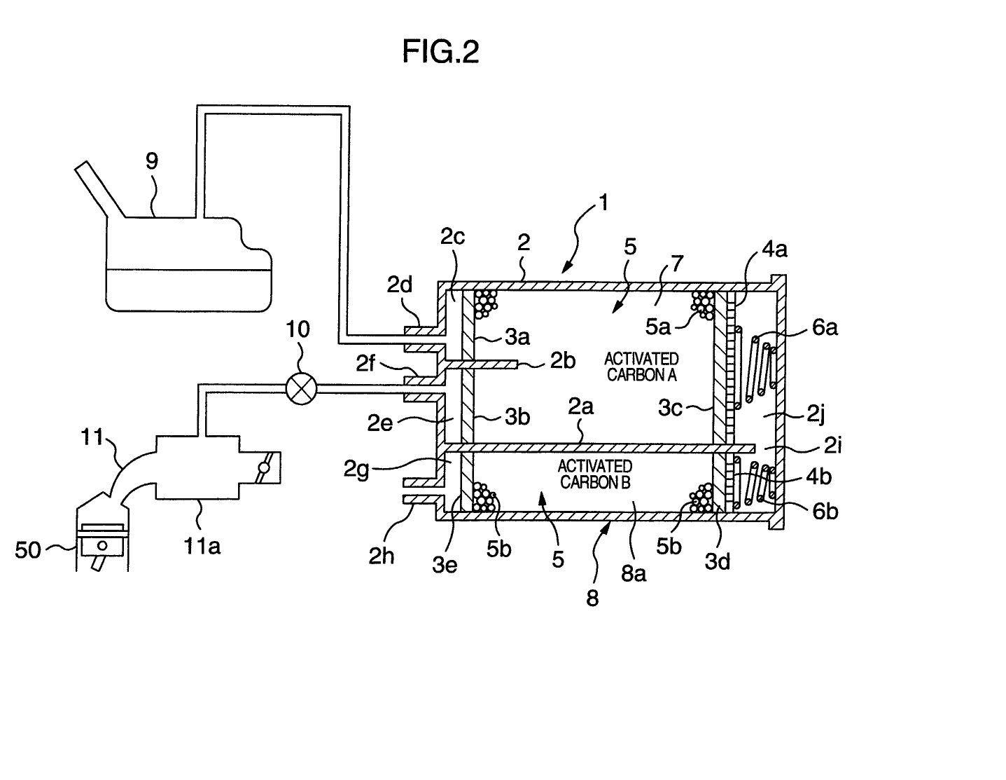

Furthermore, FIG. 2 shows a modification of the embodiment in FIG. 1.

In the modification in this drawing, the plate 4c or the filter 3f separating the second adsorbent layer 8a from the third adsorbent layer 8b in the first embodiment is removed, whereby the second adsorbent layer 8 filled with the activated carbon B is integrally constituted. This constitution permits simplifying its structure and manufacture as well as lowering a cost.

Incidentally, the other constitutions are the same as these in the first embodiment, and hence their description will be omitted.

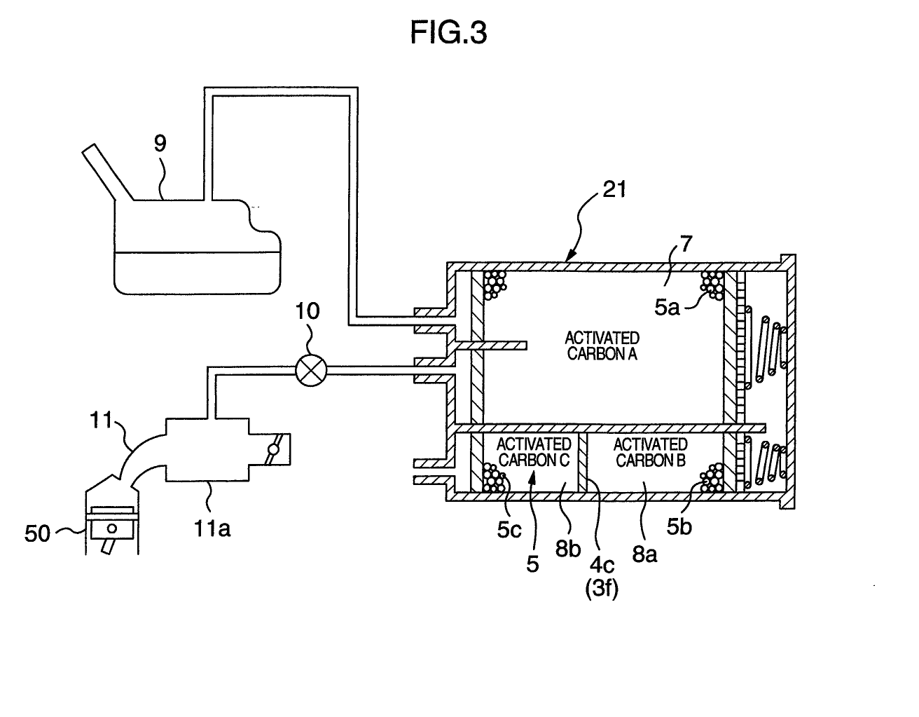

Next, a second embodiment according to the present invention will be described. It is to be noted that portions alone which are different from the first embodiment will be described, and the description of the same function portions will be omitted. FIG. 3 is a vertically sectional view of a canister according to the second embodiment of the present invention. In FIG. 3, the third adsorbent layer 8d of the canister 21 is filled, as the adsorbent 5, with the activated carbon C (5c) having a small evaporated fuel adsorption and a strong holding power and therefore containing low boiling point components of the evaporated fuel which remain in large quantities after purge. It is to be noted that the volume of the third adsorbent layer 8b is 50 cc.

Next, the function of the second embodiment will be described. Incidentally, the process until the adsorption of the evaporated fuel during the stop of the engine is the same as that in the first embodiment, and hence its description will be omitted. The description will be made from the step of the purge after the start of the engine. In FIG. 3, substantially all of the evaporated fuel adsorbed by the activated carbon C (5c) in the third adsorbent layer 8b is purged by a negative pressure of the intake pipe 11, in a purge step after the start of the engine 50. This reason is that the activated carbon C (5c) has the characteristics of allowing the low boiling point components in the evaporated fuel to remain in large quantities after the purge, but the volume of the third adsorbent layer 8b is reduced to 50 cc which is about 2.4% of 2100 cc which is the total volume, whereby the amount of purge air per unit volume can be increased to improve a purge performance.

Therefore, in the step of the high-temperature standing after the completion of the purge, the low boiling components which remain in the first adsorbent layer 7 evaporates to give rise to a diffusion phenomenon, but these components are adsorbed by the second adsorbent layer 8a filled with the activated carbon B (5b). Therefore, even if the evaporated fuel is subsequently fed from the fuel tank 9, the evaporated fuel is adsorbed by the second adsorbent layer 8a, and the evaporated fuel which is not adsorbed by the second adsorbent layer 8a is certainly adsorbed by the third adsorbent layer 8b. In consequence, the blow-by or the discharge of the evaporated fuel into the atmosphere is inhibited. In FIG. 4, the blow-by amount is less than 30 mg in the case that the feed of the evaporated fuel is 80 g, which means that the blow-by amount is remarkably smaller as compared with the conventional techniques I and II, and it is also smaller as compared with the first embodiment. Incidentally, it has been confirmed that when the volume of the third adsorbent layer 8b is in a range of 50 to 100 cc (2.3 to 4.8%) with respect to 2100 cc of the total volume, the above-mentioned effect can be maintained, but when the volume of the third adsorbent layer 8b is 200 cc, the effect decreases.

Since the present invention is constituted as described above, the following effects can be exerted. That is to say, according to the first aspect of the present invention, an adsorption layer of the first layer of a canister is filled with activated carbon A, and an adsorption layer of the second layer is filled with activated carbon B having characteristics that the residual amount of the low boiling point components in an evaporated fuel after purge is small. Therefore, after the high temperature standing of the canister, the discharge of the evaporated fuel into the atmosphere can be inhibited. Furthermore, in the above-mentioned constitution, an adsorption layer of the second layer is divided into two portions by a filter or a plate having air permeability to form the second and the third adsorbent layers in addition to the adsorbent layer of the first layer, i.e., the first adsorbent layer. Therefore, a flow resistance can be formed by the plate or the like between the second adsorbent layer and the third adsorbent layer to inhibit the amount of the evaporated fuel released into the atmosphere through the third adsorbent layer.

Furthermore, according to the second aspect of the present invention, the first adsorbent layer of the canister is filled with the activated carbon A, the second adsorbent layer is filled with the activated carbon B, and the third adsorbent layer is filled with the activated carbon C. Therefore, after the high temperature standing of the canister, the discharge of the evaporated fuel into the atmosphere can further be inhibited.

What is claimed is:

1. A canister in which adsorbent layers of a first layer and a second layer obtained by dividing an adsorbent layer with a partition wall are arrange in series, wherein the adsorbent layer of the first layer is filled with activated carbon (activated carbon A) having a large evaporated fuel adsorption and a weak holding power, and the adsorbent layer of the second layer is filled with activated carbon (activated carbon B) having an intermediate evaporated fuel adsorption and a weak holding power.

2. The canister according to claim 1, wherein the adsorbent layer of the second layer is divided into two portions by a filter or a plate having air permeability to form a second and a third adsorbent layers in the case that the adsorbent layer of the first layer is referred to as the first adsorbent layer.

3. A canister in which adsorbent layers of a first layer and a second layer obtained by dividing an adsorbent layer with a partition wall are arrange in series, wherein the adsorbent layer of the second layer is divided into two portions by a filter or a plate to form a second and a third adsorbent layers; the adsorbent layer of the first layer, i.e., the first adsorbent layer is filled with activated carbon (activated carbon A) having a large evaporated fuel adsorption and a weak holding power; the second adsorbent layer is filled with activated carbon (activated carbon B) having an intermediate evaporated fuel adsorption and a weak holding power; and the third adsorbent layer is filled with activated carbon (activated carbon C) having a small evaporated fuel adsorption and a strong holding power.

4. The canister according to claim 3, wherein the volume of the third adsorbent layer is set in a range of from 2.3 to 4.8% of the volume of the total adsorbent layers.
